(19) United States
(12) Patent Application Publication
(10) Pub. No.: US 2002/0100166 A1
(43) Pub. Date: Aug. 1, 2002

(54) Method of inserting an electrical plug into a stationary electrical receptacle

(76) Inventors: Thomas M. Sullivan, Highland, MI (US); Michelle R. Engja, Novi, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 09/775,392

(22) Filed: Feb. 1, 2001

(51) Int. Cl. H01R 43/00

(52) U.S. Cl. 29/857

(57) ABSTRACT

An electrical plug can be inserted onto a stationary electrical receptacle through the use of a portable tool that includes a stationary support surface or movable carrier for the plug, and a power device for moving the plug through a prescribed stroke distance. A high electrical contact pressure can be achieved on a consistent basis. The power device preferably takes the form of a manual lever having one end that serves as a fulcrum and a second end that serves as a handle for swinging the lever around the fulcrum, to deliver a relatively large operating force to the electrical plug.

### FIELD OF THE INVENTION

This invention relates to automotive electrical systems, and particularly electrical connections between stationary electrical receptacles and electrical plugs carried by flexible cables.

### BACKGROUND OF THE INVENTION

Automotive wiring connector systems face the conflicting requirements of low insertion forces and decreased packaging size. A related consideration is the relation between current load and contact area. Higher currents require larger contact area and increased frictional engagement between the mating contact surfaces.

Typically an electrical connection will include a stationary spade or fin containing multiple flat contact surfaces, and a mating plug located on a flexible cable. The plug can have a slot having a tight frictional fit on the spade, so that internal contacts within the plug have pressurized frictional contact with the contact surfaces on the spade.

Sometimes it becomes necessary, or desirable to increase the number of electrical contacts in a given plug-spade connection, e.g. to twenty or more contact pairs. For example, when an electrical cable is connected to a printed circuit board, the connection may include ten or more sets of electrical contacts. Similarly, a large number of pin-sleeve connections will be used when making a factory connection between a terminal block and an electrical cable in a automotive lighting system.

To minimize the overall size of the electrical connection, the designer may elect to reduce the size of the individual electrical contacts. As a result, the contact area of each contact pair can be undesirably reduced.

To compensate for the reduced contact area, the mating contacts can be designed to have increased frictional pressure between the mating contact surfaces. However, this requires a relatively high insertional force during the operation of manually installing the electrical plug onto the stationary receptacle.

A high plug insertional force requirement can present some problems for the installing technician. For example, the high frictional resistance to full insertion of the plug into the receptacle may cause the technician to stop the insertional movement prior to complete insertion of the plug onto the receptacle, with resultant inadequacies as regards electrical continuity or mechanical resistance against vibrational operational forces. If the technician should apply the insertional force at an angle to the plug-receptacle insertional axis, the contact elements can be bent or damaged.

To reduce the insertional force requirement, the plug or stationary receptacle are sometimes designed to include cams or levers for reducing the manual effort required to produce a full insertional movement of the electrical plug along the desired path. However, such cams or levers undesirably increase the overall size of the mechanical connection package.

### SUMMARY OF THE PRESENT INVENTION

The present invention relates to a tool and method of operation, wherein the insertional force is increased to a satisfactory value, without increasing the overall size of the mechanical connection (i.e. the electrical plug and stationary receptacle). In the present invention, a special tool is used to move the electrical plug along a desired insertional path. The tool is anchored to a temporary anchoring point on the receptacle support structure, so that the tool is enabled to apply a sufficient actuating force to the electrical plug without permanently adding to the overall size of the plug-receptacle package. After the plug has been inserted onto the receptacle, the tool is removed. The tool is designed to apply an actuating force to the electrical plug in the precise direction required to ensure a smooth insertion movement of the plug, without jamming or an incomplete insertional stroke.

Specific features of the invention will be apparent from the attached drawings and description of an apparatus that can be used to practice the invention.

### BRIEF DESCRIPTION OF THE DRAWINGS

FIG. 1 is a sectional view taken through an apparatus that can be used to practice the invention. The associated electrical receptacle and electrical plug are shown in section.

FIG. 2 is a sectional view taken on line 2-2 in FIG. 1.

FIG. 3 is a view, partly in section, showing another apparatus that can be used to practice the invention.

FIG. 4 schematically depicts another apparatus that can be used to practice the invention.

FIG. 5 is a view taken in the same direction as FIG. 4, but showing the apparatus in position at a later stage in the process of inserting an electrical plug onto a mating electrical receptacle.

### DESCRIPTION OF A PREFERRED APPARATUS THAT CAN BE USED IN PRACTICE OF THE INVENTION

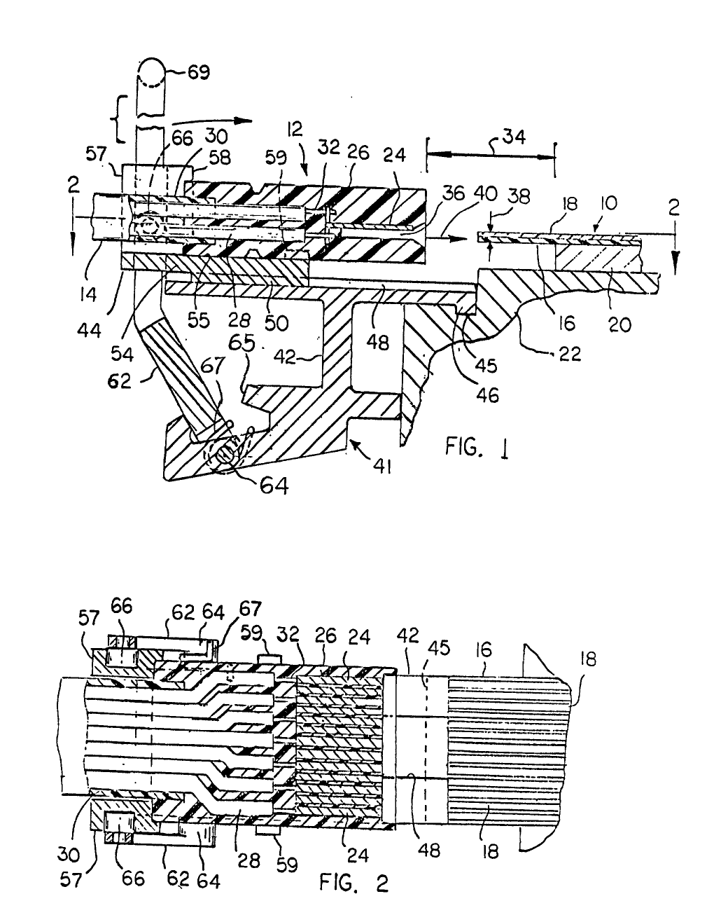

Referring to FIGS. 1 and 2, there is shown an electrical connection that can be made, or effected, by the method of the present invention., The electrical connection includes a stationary receptacle 10 and a disconnectable electrical plug 12 attached to an electrical cable 14.

Receptacle 10 includes a dielectric fin or spade 16 having multiple electrical leaf contacts 18 located on the spade upper surface. Leaf contacts 18 can be terminal areas of a printed circuit supported on a block 20. Alternately, contacts 18 can be an in-line connector to another wiring harness that is restrained in place on a solid stationary surface. In the illustrated arrangement, receptacle 10 can be suitably mounted on a stationary support structure 22.

Electrical plug 12 includes multiple leaf contacts 24 molded into a dielectric plug structure 26. Insulated lead wires 28 extend from a dielectric sheath 30 into the plug structure so that individual lead wires 32 are soldered, crimped, welded or otherwise connected, to individual leaf contacts 24. Dielectric plug structure 26 is a molded block structure that can be manually handled for insertion onto spade 16, to form electrical connections between leaf contacts 24 and leaf contacts 18. As shown in FIGS. 1 and 2, plug 12 is separated from spade 16.

To insert plug 12 onto receptacle 10 the plug is moved rightwardly from the FIG. 1 position through a stroke distance 34 so that slot 36 in the plug slides onto spade 16. The slot thickness is essentially the same as the spade thickness 38, so that when plug 12 is moved rightwardly onto the receptacle, the leaf contacts 24 in plug 12 have a pressurized frictional contact with leaf contacts 18 in spade 16. The pressurized contact promotes good electrical continuity.

The present invention relates to a tool and method for moving plug 12 along a linear path 40, so that plug 12 achieves the full stroke distance 34 without undue effort on the part of the human technician. The invention contemplates the use of a tool 41 that includes a holder 42 and plug carrier 44.

Holder 42 includes an arm structure adapted to seat against receptacle support structure 22 to assume a stationary position. The arm structure includes a downwardly extending protuberance 45 that can lock into a specially-formed indentation 45 in receptacle support structure 22, so that when holder 42 is manually placed against structure 22 the holder assumes a stationary position. In an alternate arrangement, the indentation can be formed on holder 42 and the protuberance can be formed on support structure 10. Indentation 45 is located relative to spade 16 so that when holder 42 is placed on support structure 22 slot 36 is aligned with spade 16 (horizontally and laterally. The holder can be manually moved onto support structure 22 and later removed for use on another similarly constructed structure, i.e., another automotive vehicle or vehicle electrical sub-system. The tool is intended for repetitive use in a production environment as a manual device for installing plugs 12 onto receptacles 10. During an eight hour shift the tool might be used one thousand times or more, as an aid to connect individual plugs 12 to individual receptacles 10.

The-upper surface of holder 42 has an inverted V cross-sectioned guide slot 48 therein for slidably receiving a dovetail cross-sectioned slide 50 carried by plug carrier 44. The plug carrier is freely movable along the upper surface of holder 42. Carrier 44 includes a horizontal wall 54 that forms a flat seating surface 55 for plug 12. The carrier also includes two upstanding end walls 57 that are spaced apart to form a slot that accommodates cable 14 when plug 12 is placed on surface 55. Each end wall 57 includes a lip 58 that overlies the plug 12 upper surface, to prevent the plug from upward dislocation off of sealing surface 55. Lateral dislocation of plug 12 is prevented by two lugs 59 extending upwardly from wall 54.

Plug 12 is positioned in plug carrier 44 by moving the plug onto seating surface 55 and then shifting the plug to the left, so that lips 58 overlie the plug, as shown in FIG. 1. With plug 12 positioned on carrier 44, a manual lever 62 is swung in a left-to-right direction to move plug structure 12 onto electrical receptacle 10.

As shown in FIG. 1, lever 62 has a pivotal connection 64 with holder 42, whereby the lever can be manually swung in a left-to-right direction from the FIG. 1 position. The lever carries two rollers 66 that are located in vertical guideways (slots) in end walls 57 of carrier 44, so that swinging movement of the lever from FIG. 1 position is translated into linear movement of plug carrier 44 along linear path 40. A relatively light torsion spring 67 normally retains lever 62 and carrier 44 in the retracted position depicted in FIG. 1.

Lever 62 includes a handle means 69 located a significant distance from rollers 66, such that a given manual force on the handle means produces a magnified force carrier 44. This is advantageous in that electrical plug 12 can be transported with considerable force onto spade 12 of receptacle 10. The plug can achieve the full stroke distance 34 on a consistent basis, so that leaf contacts 24 have maximum surface area engagement with leaf contacts 18. The spade thickness 38 can be dimensioned to achieve a desired pressure contact between the electrical surfaces, without fear that the technician will be unable to achieve a full insertion of plug 12 on a consistent basis. Holder 42 can include a stop surface 65 for limiting the insertional movement of lever 62, so that the mating connection cannot be overstroked so as to possibly damage the joint defined by receptacle 10 and plug 12.

After plug 12 has been inserted onto receptacle 10, lever 62 is moved back to the FIG. 1 position, either manually and/or by spring 67, whereby carrier 44 is returned along path 40 to the starting position. Tool 41 can then be removed from receptacle structure 22 for use on another vehicle or electrical sub-assembly.

A principal advantage of the invention is that electrical plug 12 can achieve a strong frictional grip on spade 16, on a consistent basis. At the same time, tool 41 is separate from plug 12, so that the overall size of the plug 12-receptacle 10 assembly can be relatively small.

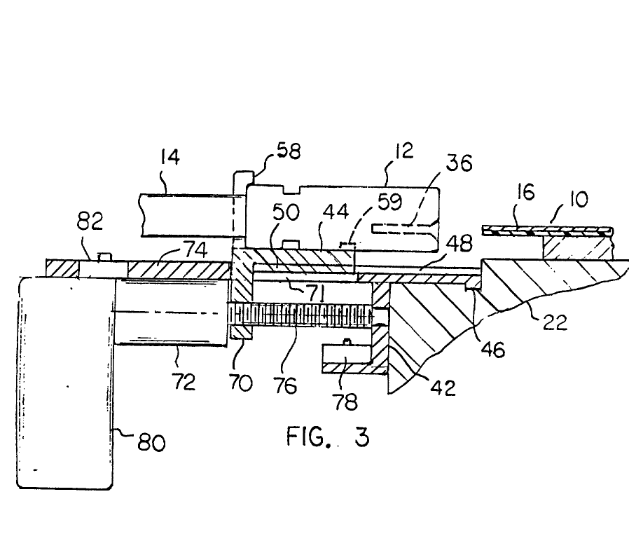

FIG. 1 represents a preferred tool and method of the present invention. However, it will be appreciated that various mechanisms can be employed to achieve the desired motion of plug carrier 44. FIG. 3 shows one alternate mechanism that might be used for moving carrier 44 along the desired path 40.

As shown in FIG. 3, carrier 44 has a tongue 70 that extends downwardly through a slot 71 in holder 42. A small torque motor 72 is mounted on the underside of holder wall 74 for rotating a screw 76. Tongue 70 has a threaded hole surface in mesh with screw 76, so that motor rotation causes tongue 70 (and carrier 44) to move in a left-to-right direction. A limit switch 78 can be used to limit the stroke of carrier 44, and return the carrier to the starting position.

As illustratively shown in FIG. 3, the tool can be manipulated by a pistol grip handle 80 suitably affixed to holder 42. A control switch 82 can be employed for initially energizing motor 72. As previously noted, switch 78 reverses the motor rotation to return holder 42 to the FIG. 3 retracted position.

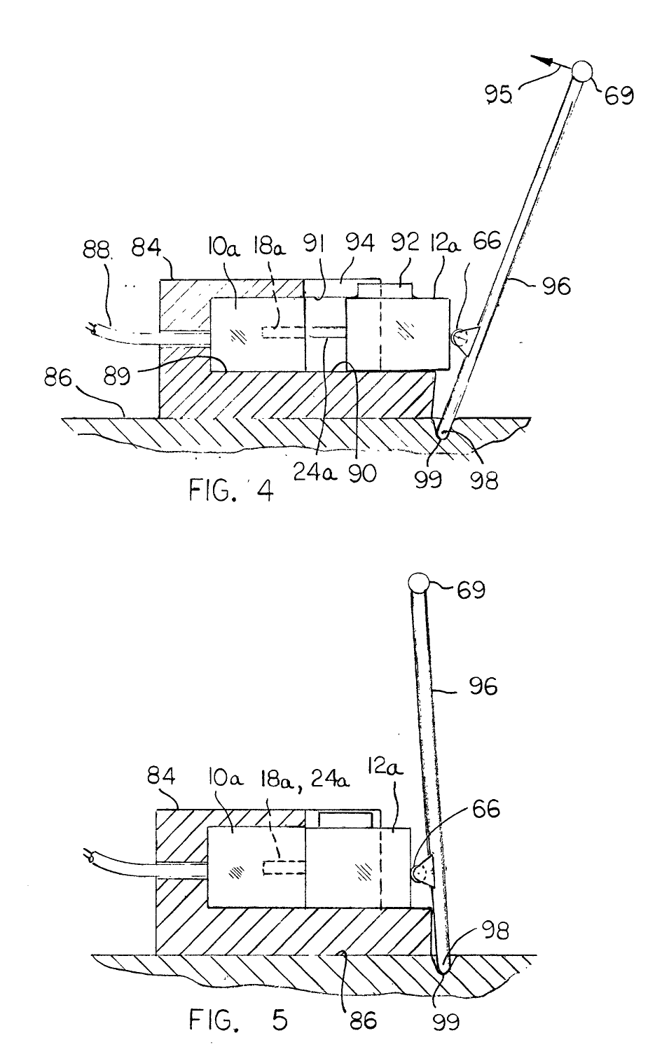

The operation of the FIG. 3 tool is similar to that of the FIG. 1 tool. In both cases, the power mechanism (lever or motor) transports electrical plug 12 with sufficient force to achieve a complete stroke distance 34 and a relatively high frictional pressure between leaf contacts 18 and 24, on a consistent basis. FIGS. 4 and 5 illustrate another apparatus that can be used to practice the invention. As shown in FIGS. 4 and 5, a stationary electrical receptacle 10a is located within a housing 84 that is suitably fastened to a support surface 86. Electrical receptacle 10a has two or more socket-like contacts 18a and a lead wire 88 connected to other circuitry in the vehicle. Receptacle 10a fits snugly within a cavity 89 in housing 84 so as to be immovable.

Housing 84 has a floor surface 90 and a roof surface 91. The floor surface extends rightwardly beyond electrical receptacle 10a to form a temporary shelf-like support structure for an electrical plug 12a.

Electrical plug 12a ha two or more prong-like electrical contacts 24a adapted to mate with electrical sockets 18a in receptacle 10a. When plug 12a is placed on floor surface 90, contacts 24a are in linear alignment with stationary contacts 18a. The plug can have a guide fin 92 that slidably mates with a slot 94 in roof surface 91, to promote the desired alignment of the electrical contacts.

FIG. 5 shows plug 12a in its inserted position wherein electrical prongs 24a are in tight frictional contact with electrical sockets 18a. The plug is moved from the FIG. 4 position to the FIG. 5 position by means of a separate lever implement 96. As shown in the drawings, implement 96 includes a straight rod having a lower end 98 insertable into a socket 99 in support surface 86 and an upper end that is attached to a cross bar (or handle) 69.

In preferred practice of the invention, the lower end of the rod has a spherical configuration, that mates with a concave spherical seating surface formed by socket 99. When the rod-like implement is inserted into socket 99, as shown in FIG. 4, the spherical lower end of the rod forms a fulcrum point for the lever (rod), whereby the rod can be swung to the FIG. 5 position by applying a manual force 95 to handle 69. Swinging motion of the rod transports plug 12a from the FIG. 4 position to the FIG. 5 position.

The rod-like implement can be equipped with a roller 66 to minimize frictional interference between the lever and the rear surface of plug 12a. Housing 84 can be constructed to limit movement of the lever in the plug-insertion direction, as shown in FIG. 5. After plug 12a has been inserted onto receptacle 10a the lever-like implement 96 can be removed from socket 99 for another usage on a different plug-receptacle assembly.

In many respects, the FIG. 4 apparatus functions similarly to the FIG. 1 apparatus. In both cases the electrical plug is placed on a temporary support structure so as to be in linear alignment with the associated plug. In both cases, a manual lever is used to advance the electrical plug along a linear path to an inserted position on the associated electrical plug. Due to the location of the lever fulcrum and lever handle, the lever provides a mechanical advantage between the applied manual force and the force delivered to plug 12 (or 12a). A relatively small manual force applied to the handle produces a larger plug insertion force.

While the drawings show specific apparatus that can be used in practicing the invention, it will be appreciated that the apparatus can be varied in accordance with different plug and receptacle configurations.

What is claimed:

1. A method of inserting an electrical plug onto a stationary electrical receptacle, comprising the steps of:
(1) positioning an electrical plug in a plane that is in linear alignment with a stationary electrical receptacle;
(2) manually positioning a lever in a stationary retracted position relative to the electrical receptacle, so that the fulcrum point for the lever is offset in one direction from the aforementioned alignment plane; and
(3) applying a manual force to the lever at a point on the lever that is offset in a opposite direction from the aforementioned alignment plane so that swinging motion of the lever around the lever fulcrum point transports the electrical plug along a linear path to an inserted position on the stationary receptacle.

2. The method of claim 1, wherein step (1) is carried out by placing the electrical plug on a shelf that is proximate to the electrical receptacle.

3. The method of claim 1, wherein step (1) is accomplished by placing the electrical plug on a movable carrier.

4. The method of claim 1, wherein step (2) is carried out by manipulating a holder for the lever to a stationary position on an electrical support structure, so that the lever assumes a retracted position.

5. The method of claim 1, wherein step (2) is accomplished by manipulating the lever to a position wherein one end of the lever is located in a socket formed in a stationary support surface, so that said one end of the lever is enabled to serve as a fulcrum.

6. The method of claim 1, wherein step (3) is carried out so that the lever fulcrum point is formed by one end of the lever, and the manual force is applied to the other end of the lever.

7. A method of inserting an electrical plug onto a stationary electrical receptacle, comprising the steps of:
(1) positioning an electrical plug on a shelf proximate to a stationary electrical receptacle, so that electrical contacts on the plug are in linear alignment with electrical contacts in the receptacle;
(2) manually positioning a lever in a retracted position, wherein one end of the lever is located within a socket formed in a stationary support surface; and
(3) applying a manual force to the other end of the lever so that the lever swings around said one end to exert sufficient force on the plug to transport the plug along a linear path to an inserted position on the stationary receptacle.

8. The method of claim 7, wherein step (1) involves the act of inserting the electrical plug partway into a housing for the stationary electrical receptacle.

9. A method of inserting an electrical plug onto a stationary electrical receptacle, comprising the steps of:
(1) positioning an electrical plug on a movable plug carrier;
(2) setting said carrier in a retracted position on a holder;
(3) manipulating the holder to a stationary position on an electrical receptacle support structure;
(4) applying a force to said carrier, to transport the electrical plug along a linear path to an inserted position on the stationary receptacle; and
(5) moving the carrier back to the retracted position, to separate the carrier from the electrical plug.

10. The method of claim 9, wherein steps (4) and(5) are carried out by applying a manual force to a lever that is pivotably connected to the holder.

11. The method of claim 9, wherein steps (4) and (5) are carried out by applying a manual force to a lever that is trained between the holder and the carrier.

12. The method of claim 9, wherein step (4) includes placing a protuberance on the holder into an indentation on the receptacle support structure.
